(19) United States
(12) Patent Application Publication
(10) Pub. No.: US 2023/0264280 A1
(43) Pub. Date: Aug. 24, 2023

(54) METHOD FOR MACHINING AND PRODUCING A TOOTHED PORTION ON A WORKPIECE

(71) Applicant: GLEASON-PFAUTER MASCHINENFABRIK GMBH, Ludwigsburg (DE)

(72) Inventor: Jürgen Kreschel, Hemmingen (DE)

(21) Appl. No.: 18/005,368

(22) PCT Filed: Jul. 22, 2021
(86) PCT No.: PCT/EP2021/070590

§ 371 Date: Jan. 13, 2023

(30) Foreign Application Priority Data
Jul. 23, 2020 (DE) 102020004472.7

(51) Int. Cl. B23F 5/16

(52) U.S. Cl. CPC B23F 5/163

(57) ABSTRACT

the invention relates to a method for machining or producing a toothed portion (2) on a workpiece by means of a tool toothed portion (4), wherein the tool toothed portion is brought into a first machining engagement with the rotating workpiece toothed portion clamped in a clamped setup, such that there is rolling coupling which assigns the teeth of the tool toothed portion to the tooth spaces of the workpiece toothed portion, and wherein the tool toothed portion is brought into a second machining engagement phase-shifted by at least one fourth of the pitch in comparison with the rolling coupling of the first machining engagement at the machining distance of deepest advancement, said second machining engagement having increased machining distance from the workpiece toothed portion clamped in the same clamped setup of the first machining engagement in comparison with the deepest advancement of the first machining engagement. The invention also relates to a control program having control instructions, which, when executed on a controller of a gear cutting machine, cause said gear cutting machine to carry out the method. The invention also relates to a gear cutting machine therefor.

The invention relates to a method for machining or producing a toothed portion on a workpiece by means of a tool toothing, with which the tool toothing is brought into a first machining engagement with the rotating workpiece toothing clamped in a clamped setup, such that there is a gear coupling which assigns its teeth to the tooth spaces of the workpiece toothed portion.

Such gear machining is, of course, well known and is practiced, for example, in the form of gear hobbing, gear shaping, or gear skiving. With gear coupling, the tool toothing is assigned to the tooth spaces of the workpiece toothing, such that the tooth tips of the tool toothing work in the foot region of the workpiece toothing and shape it by shape forming where necessary, whereas the tooth tips of the workpiece toothing are located in the foot region of the tool toothing and can be influenced by its shaping. In this manner, for example, the tooth tip height can be set on the workpiece, provided this is not done using a separate tool such as a roller.

The invention is based on the object of improving a method of the type described above with regard to a favorable combination of the simplest possible method design and satisfactory precision of any subsequent further processing.

This object is achieved in terms of process engineering by a further development of the method of the type mentioned at the beginning, which is substantially characterized in that the tool toothing is brought into a second machining engagement phase-shifted by at least one fourth of the pitch in comparison with such assignment of the gear coupling of the first machining engagement, in particular at the machining distance of deepest advancement, said second machining engagement having an increased machining distance from the workpiece toothing clamped in the same clamped setup of the first machining engagement in comparison with the deepest advancement of the first machining engagement.

Thus, according to the invention, it has been recognized that, by machining the workpiece toothing in a phase-shifted manner compared to regular gear coupling, a toothing machining of, for example, the tooth tips of the workpiece toothing is made possible independently of the shaping of the foot region of the tool toothing, and in this respect flexibility is increased, and the method is simplified by the absence of additional tools, and thereby nevertheless the reference rotation axis of gear producing/machining and of the machining surface of the second machining engagement remains the same due to the coupling of the machining engagements via the same workpiece clamped setup. In this manner, for example, the tip diameter can be used as a positioning surface for grippers or during clamping for subsequent additional machining, without positioning or clamping errors caused by a different rotation axis reference of the positioning surface to the rotation axis reference of the workpiece toothing. The synchronization of the rotary axes of the gear coupling of the first machining engagement can thereby be maintained.

In a preferred embodiment, as mentioned above, the second machining engagement causes the tooth tips of the workpiece toothing to be machined by the tooth tips of the tool toothing. The phase shift is then in a range around one half of a pitch corresponding to the extension of the workpiece tooth tip in the circumferential direction.

In this connection, it is provided that a machining region of the second machining engagement covers different phase shifts. On the one hand, this enables the machining of workpiece tooth tips with an asymmetrical workpiece design, and on the other hand, it increases the flexibility and/or accuracy of the method.

In a preferred type of method, the tooth tip diameter of the workpiece toothing is determined by contact lines of the second machining engagement. The method is therefore used to selectively set the tooth tip diameter and not (only) to shape it. However, these are also considered; for example, a tip phase could be produced with the method according to the invention by superimposing a radial (x) machine axis movement beyond an axial (z) machine axis movement on the phase-shifted gear coupling.

In a particularly preferred embodiment, the deviation in the tip diameter of the workpiece toothing from its mean value taken over a workpiece tooth is less than 200 μm, preferably less than 80 μm, in particular less than 20 μm. Where necessary, different phase shifts are used for this purpose during the second machining engagement, such that the tip diameter is obtained via the enveloping of the contact lines for the partial machining operations that are phase-shifted relative to one another.

In a particularly preferred embodiment, the method is executed in a feeding motion of the second machining engagement, the main motion component of which is directed along the workpiece rotation axis (Z). This allows the effects described above to be extended to, for example, the entire toothing width, or only part of it if desired.

In a likewise preferred embodiment, a continuous phase shift is used in the second machining engagement, in particular an oscillating phase shift. The machining of, for example, the tooth tips of the workpiece toothing then takes place, figuratively speaking, at different heights of the toothing width, once from the right flank to the left flank, and once from the left flank to the right flank. It is understood that the feed must be adjusted for this purpose.

With the method, preferably the ratio of oscillation frequency of phase shift to workpiece speed is given by (2k+1)/(2m), where m is greater than 2 and preferably less than 10, in particular less than 7, preferably less than or equal to 4, and k is greater than or equal to 0 and preferably less than 10, in particular less than 7, and preferably k and/or m are integers.

In a preferred shaping, the first machining engagement is a machining engagement of gear skiving or hard skiving, in particular with a skiving wheel ground by step grinding. The flexibility according to the invention is particularly effective for this machining operation. Preferably, the first and second machining are performed with the same axis cross angle.

In a preferred embodiment, the phase shift is produced by means of an additional rotation of workpiece and/or tool toothing, in particular by means of an additional rotation of the workpiece teeth. However, tangential linear machine axes can also be used to achieve the phase-shifted position. Preferably, however, the tangential axis is as with the first machining.

With regard to the surface formed in the second machining engagement and its suitability as a grippable and/or positioning determination surface, the invention therefore also relates to a method for machining or producing a toothing in a workpiece by means of tool toothing, in which the tool toothing is brought into a first machining engagement with the workpiece toothing rotating in a clamped setup under a gear coupling which assigns its teeth to the tooth spaces of the workpiece toothing, in particular according to one of the aspects described above, in which an optionally also discontinuous surface, which differs from the tooth foot regions of the workpiece toothing and serves as a grippable and/or as a positioning determination surface and which is substantially annular in section orthogonal to the workpiece rotation axis, is produced with the tooth tip regions of the tool toothing by removing material by cutting on the workpiece clamped in the same clamped setup.

Furthermore, the invention also relates to a control program comprising control instructions defined in accordance with the method aspects defined above, and also to a gear cutting machine, which is capable of executing such a method by means of corresponding control instructions.

Further features, details and advantages of the invention will be apparent from the following description with reference to the accompanying figures, of which

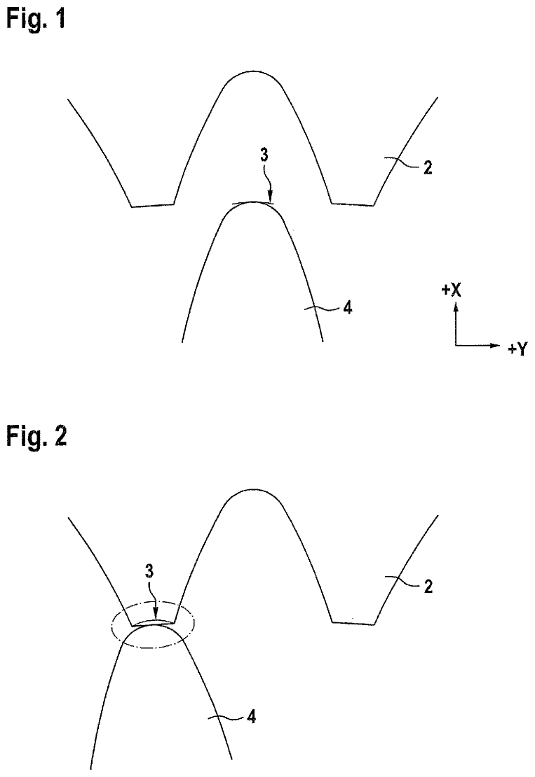

FIG. 1 shows a relative position of workpiece and tool toothing,

FIG. 2 shows another relative position of workpiece and tool toothing,

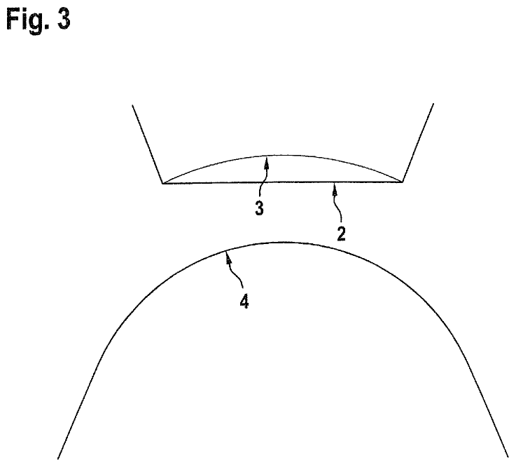

FIG. 3 shows a more detailed illustration of tooth tips,

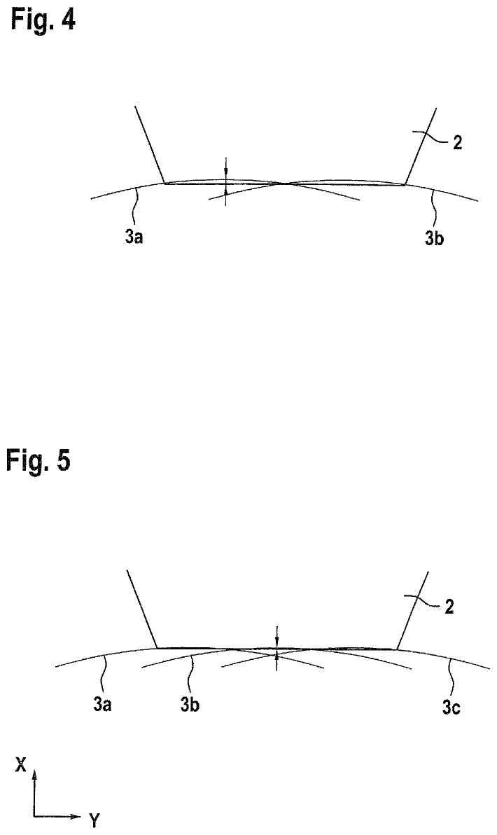

FIG. 4 shows contact lines of different phase shifts,

FIG. 5 shows contact lines of different phase shifts,

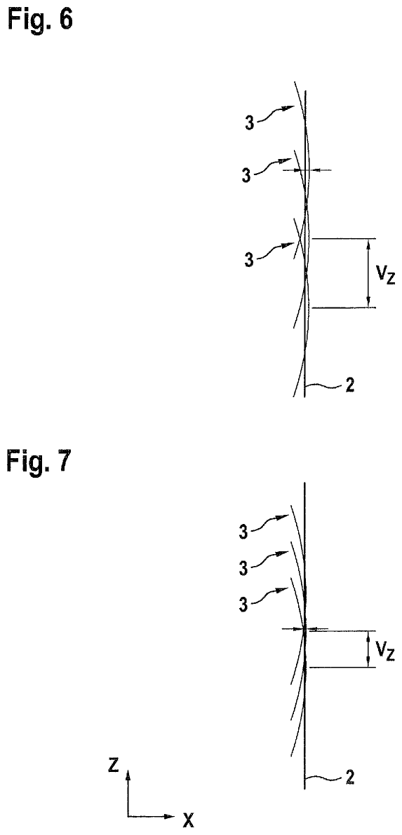

FIG. 6 shows an illustration of contact lines with a feed motion,

FIG. 7 shows another illustration of contact lines with a feed motion, and

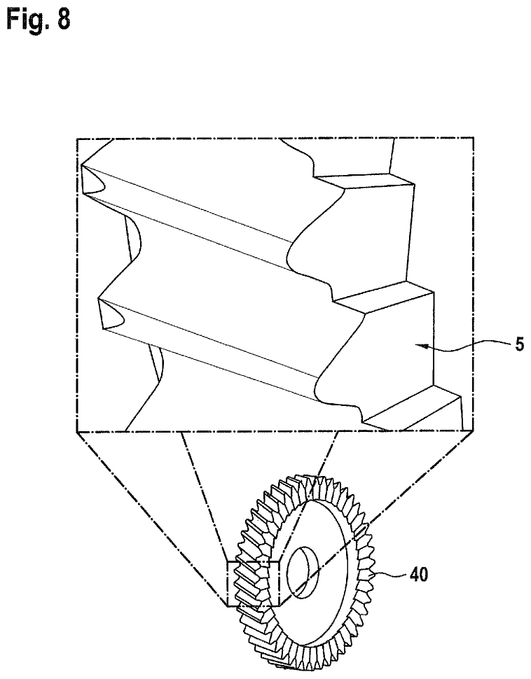

FIG. 8 shows a skiving wheel with stair grinding.

FIG. 1 shows a workpiece toothing, in this case an internal toothing, and is designated with 2. A tool tooth 4 is shown in a position that, with regard to the gear coupling of a machining method for producing the toothing 2, substantially corresponds to that of the deepest advancement (the contact line 3 which is very short would lie in the tooth foot of the workpiece toothing 2 when there is deepest advancement). The phase position shown in FIG. 1 therefore corresponds, for example, to the situation in which radial retraction of the tool from the workpiece has taken place after production of the workpiece toothing 2 while gear coupling is maintained.

Normally, with conventional machining methods, this is the end of machining (in continuous rolling machining methods, all tooth spaces of the workpiece toothing are produced simultaneously), and the workpiece is unclamped and, where necessary, transferred to another machining station, for example for the tooth face chamfering phase.

In contrast, however, another machining operation is now performed, specifically one of the tooth tips of the workpiece toothing 2 in a machining engagement that is phase-shifted with respect to the gear coupling of the first machining engagement. As can be seen from FIGS. 1 and 2, the phase shift here is one half the pitch. As a result, the tip of the tool tooth 4 comes into machining contact with the tip of a tooth of the workpiece toothing 2, the region circled oval in FIG. 2 is shown again in FIG. 3 in another enlarged illustration, a contact line 3 of the machining engagement can be seen, which continues to take place in the machining mode of the first machining, here, for example, of gear skiving (the contact line 3 is not a 1-to-1 impression of the profile of the cutting tooth 4, but results from this profile taking into account the machine axis movements of the method as an enveloping curve of the machining positions of the tool tooth in the employed machine axis kinematics of gear skiving).

FIGS. 1 to 3 therefore describe the principle of phase shifting used for the second machining engagement, whereas preferably several different phase shifts are superimposed in order to achieve more accurate tooth tip machining of the workpiece toothing 2. The effect of these is described in FIGS. 4 and 5; FIG. 4 shows two contact lines 3a, 3b with different phase shifts; compared with FIG. 3, the more uniform tooth tip surfaces produced by such contact lines (indicated by the arrows, 36 μm in this example) are clearly visible, and this is even more pronounced in the illustration of FIG. 5 in which three contact lines 3a, 3b, 3c are drawn, each with a different phase shift between them, and in which a deviation (approximately 6 μm) from the shown envisioned target tooth tip surface is barely visible to the naked eye.

By means of additional advancement in the radial direction X, using the described method, the tip diameter of the workpiece toothing can therefore be set, tracked or designed according to one's own requirements.

If the toothing is already pre-toothed before the first machining engagement of the gear machining operation itself, the second machining engagement can also be carried out chronologically prior to the first machining engagement; therefore, the terms “first” and “second” are not to be understood as a temporal sequence, although such a temporal sequence is a preferred embodiment.

The illustration of engagement via contact lines described in FIGS. 1 to 5 only in a face section plane to the workpiece rotation axis is supplemented in FIGS. 6 and 7 by an illustration that also takes into account an axial feed V_{z} in the direction of the workpiece rotation axis Z, since, in this exemplary embodiment, the second machining engagement is to be carried out over the full toothing width of the workpiece toothing 2. FIG. 6 shows contact lines in a radial-axial plane X, Z, taking into account a feed of 1 mm (per workpiece rotation) in FIG. 6, which would still lead to a deviation of 35 μm compared to a radial reference in this example, whereas (FIG. 7) halving the feed rate already reduces the deviation in this respect to 9 μm in this exemplary embodiment.

It is understood that the numerical values used here are only for explanatory purposes, and the feed rate can also be different, in particular in the preferred ranges described above.

Likewise, with reference to FIGS. 4 and 5, it is understood that the phase shift does not have to be set abruptly to discrete phase shift values, but rather, after a one-time phase shift of the correct order of magnitude, in order to establish machining contact between the tooth tips of the workpiece and tool toothing, a continuous increase in phase shift can be set to cover the entire tooth tip surface of the workpiece toothing 2.

It is also understood that, for example compared to the splitting shown in FIG. 5 with contact lines 3a, 3b, 3c of different phase shifts (but always in the range of an order of magnitude of a half pitch compared to the first machining in deepest advancement), which lie together at the same tooth height as viewed in toothing width, and are guided by the axial feed over the entire toothing width, according to the axial feed described, for example, with reference to FIG. 7, the contact line 3c from FIG. 5 could be extended over the full tooth width by axial feed, followed by the contact line 3b and finally the contact line 3a, or in a different sequence or a mixed form of such two variants.

Preferably, if the machining engagement is that of gear skiving or hard skiving, a tool 40, the cutting faces 5 of which are ground in a step grind, as shown in FIG. 8, and which both produces and/or machines the workpiece toothing 2 by way of tooth flank machining, and also machines its tooth tips or tooth tip faces and thereby in particular sets a tooth tip diameter of the workpiece toothing 2, is used for the machining operation.

The surface created in this manner in the form of the tooth tip surfaces of the workpiece toothing 2 can also be used as a positioning or gripping surface for grippers of an automation system or clamping devices. Due to the machining by the same rolling machining engagement in the same workpiece clamped setup for both the toothing itself and the tooth tip surfaces, precise clamping for subsequent machining steps is facilitated.

The invention is not limited to the individual features of the exemplary embodiments. Rather, the features of the foregoing description and of the claims below may be individually and in combination essential to the implementation of the invention in its various embodiments.

1. A method for machining or producing a toothing (2) in a workpiece by means of tool toothing, in which the tool toothing is brought into a first machining engagement with the rotating workpiece toothing clamped in a clamped setup, such that there is a gear coupling which assigns tool teeth (4) to the tooth spaces of the workpiece toothing,
characterized in that
the tool toothing is brought into a second machining engagement phase-shifted by at least one fourth of the pitch in comparison with such assignment of the gear coupling of the first machining engagement, said second machining engagement having increased machining distance from the workpiece toothing clamped in the same clamped setup of the first machining engagement in comparison with the deepest advancement of the first machining engagement.

2. The method according to claim 1, in which the second machining engagement causes the tooth tips of the workpiece toothing to be machined by the tooth tips of the tool toothing.

3. The method according to claim 1, in which a machining region of the second machining engagement covers different phase shifts.

4. The method according to claim 1 in which the tooth tip diameter of the workpiece toothing is determined by contact lines of the second machining engagement.

5. The method according to claim 1 in which the deviation in the tip diameter of the workpiece toothing from its mean value taken over a workpiece tooth is less than 200 μm.

6. The method according to claim 1 comprising a feed motion of the second machining engagement, the main motion component of which is directed along the workpiece rotation axis.

7. The method according to claim 1 comprising a continuous phase shift in the second machining engagement.

8. The method according to claim 16, in which the ratio of oscillation frequency of phase shift to workpiece speed is given by (2k+1)/(2m), wherein m is greater than 2 and less than 10, and k is greater than or equal to 0 and less than 10.

9. The method according to claim 1 in which the first machining engagement is a machining engagement of gear skiving or hard skiving.

10. The method according to claim 9, in which the tool toothing is a skiving wheel ground by step grinding.

11. The method according to claim 1 in which the phase shift is produced by means of an additional rotation of workpiece and/or tool toothing.

12. A method for machining or producing a toothing in a workpiece by means of tool toothing, in which the tool toothing is brought into a first machining engagement with the workpiece toothing rotating in a clamped setup under a gear coupling which assigns its teeth to the tooth spaces of the workpiece toothing according to the method of claim 1, in which an additional discontinuous surface, which differs from the tooth foot regions of the workpiece toothing and serves as a grippable and/or as a positioning determination surface and which is substantially annular in section orthogonal to the workpiece rotation axis, is produced with the tooth tip regions of the tool toothing by removing material by cutting on the workpiece clamped in the same clamped setup.

13. A control program comprising control instructions that, when executed in a controller of a gear cutting machine, causes the machine to carry out a method according to claim 1.

14. A gear cutting machine comprising a workpiece spindle for clamping a rotationally drivable workpiece, a tool spindle for rotationally driving tool toothing, at least one positioning and/or setting axes for positioning the tool rotation axis relative to the workpiece rotation axis, and a control device that controls by control instructions for executing a method according to claim 1.

15. The method according to claim 1 wherein the second machining engagement is phase-shifted by at least one fourth of the pitch in comparison with such assignment of the gear coupling of the first machining engagement at the machining distance of deepest advancement.

16. The method according to claim 7 wherein the continuous phase shift in the second machining engagement comprises an oscillating phase shift.

17. The method according to claim 8 wherein k and/or m are integers.
